(19) United States
(12) Patent Application Publication
(10) Pub. No.: US 2024/0070587 A1
(43) Pub. Date: Feb. 29, 2024

(54) ENQUIRY ENGINE FOR DEVELOPING BUSINESS QUESTIONS

(71) Applicant: MU SIGMA BUSINESS SOLUTIONS PVT. LTD., Whitefield (IN)

(72) Inventors: Zubin Dowlaty, Bluffton, SC (US); Dhiraj C. Rajaram, Palo Alto, CA (US)

(21) Appl. No.: 17/899,072

(22) Filed: Aug. 30, 2022

(51) Int. Cl. G06Q 10/06

(52) U.S. Cl. CPC G06Q 10/06375

(57) ABSTRACT

An enquiry engine for systematically developing business questions for an organization is provided. The engine includes a problem definition module to analyze at least one business problem and develop a plurality of hypothesis based on a current state, a desired state and one or more business gaps between the current and desired states, a business transformation module to determine outcomes for the business problem, a complexity representation module to represent organizational complexity and interconnections between problem areas, a progress monitoring module to monitor progress of solutions implemented by different types of stakeholders to achieve the desired state, and a questions design module to integrate information from the problem definition module, the business transformation module, the complexity representation module, and the progress monitoring module to systematically develop one or more business questions corresponding to the business problem.

### FIELD

The present invention relates to a system and method to facilitate decision making in organizations and, more particularly, to techniques relating to systematically develop business questions for organizations to enable data driven decision for the organizations.

### BACKGROUND

A large amount of data is available with organizations as they strive to utilize such data for enabling data driven decisions to solve business problems. Some organizations develop signal engines that may be able to implement descriptive, inquisitive, predictive and prescriptive analytics using the available data to determine answers to business questions.

However, for organizations to be efficient it is required that relevant business questions are developed in a systematic, consistent and in a scalable manner, while reducing the cost and effort for developing such business questions.

In addition, as organizations scale, complexity also increases. This creates siloes in the business and may curtail free flow of learnings/solutions across business functions of the organizations. This may lead to inefficiencies due to lack of transparency, persistence, and cumulativeness across the organization.

Unfortunately, this may result in substantial effort and high costs of developing business questions which may lead to fewer high-quality decisions within the organization.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, an enquiry engine for systematically developing business questions for an organization is provided. The enquiry engine includes a problem definition module configured to analyze at least one business problem of an organization and to develop a plurality of hypothesis corresponding to the business problem based on a current state, a desired state and one or more business gaps between the current and desired states. The enquiry engine also includes a business transformation module configured to determine outcomes for the business problem over multiple phases, shared behaviors and insights required by a plurality of stakeholders of the organization to achieve the outcomes and a complexity representation module configured to represent organizational complexity and interconnections between problem areas across business functions of the organization. The enquiry engine further includes a progress monitoring module configured to communicate with the problem definition module, the business transformation module, and the complexity representation module to monitor progress of solutions implemented by different types of stakeholders to achieve the desired state and a questions design module configured to integrate information from the problem definition module, the business transformation module, the complexity representation module, and the progress monitoring module to systematically develop one or more business questions corresponding to the business problem.

According to another example embodiment, an enquiry engine for systematically developing business questions for an organization is provided. The enquiry engine includes a memory having computer-readable instructions stored therein and a processor. The processor is configured to identify a business problem for the organization and to analyze the business problem of an organization and identify one or more business questions corresponding to the business problem based on a current state, a desired state and one or more business gaps between the current and desired states. The processor is further configured to access business information related to the business problem from a plurality of business functions across the organization. Business information comprises outcomes for the business problem, shared behaviors and insights required by a plurality of stakeholders of the organization to achieve the outcomes. The processor is further configured to map one or more business questions that correspond to the identified insights and monitor progress of solutions developed by stakeholders across the business functions to achieve the desired state and to develop and/or refine one or more business questions corresponding to the business problem using the business information and solutions.

According to another example embodiment, a computer-implemented method for systematically developing business questions for an organization is provided. The method includes analyzing a business problem of an organization and developing a plurality of hypothesis corresponding to the business problem based on a current state, a desired state and one or more business gaps between the current and desired states. The method also includes accessing business information related to the business problem from a plurality of business functions across the organization. Business information includes outcomes for the business problem, shared behaviors and insights required by a plurality of stakeholders of the organization to achieve the outcomes. The method further includes mapping one or more business questions that correspond to the identified insights and monitoring progress of solutions developed by stakeholders across the business functions to achieve the desired state, identifying organizational complexity and interconnections between problem areas across business functions of the organization and developing and/or refining one or more business questions corresponding to the business problem using the business information and solutions.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates an enquiry engine for systematically developing business questions for an organization in accordance with embodiments of the present technique;

FIG. 2 illustrates an example representation of states of a business problem analyzed by the system of FIG. 1;

FIG. 3 illustrates an example representation of output from the system of FIG. 1;

FIG. 4 illustrates an example representation of gaps between the current and desired states as identified by the system of FIG. 1;

FIG. 5 illustrates an example representation of factors identified for identified business gaps of FIG. 4;

FIG. 6 illustrates an example representation of a hypothesis matrix for the hypothesis generated using the system of FIG. 1;

FIG. 7 illustrates an example representation of key questions generated using the hypothesis matrix of FIG. 6;

FIG. 8 illustrates an example screenshot of output from the business transformation module of FIG. 1;

FIG. 9 illustrates an example representation of interactions in an organization generated by the complexity representation module of FIG. 1; and

FIG. 10 is a block diagram of an embodiment of a computing device in which the modules of an enquiry engine for systematically developing business questions for an organization, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to techniques for systematically developing business questions for an organization. In particular, the embodiments are directed to techniques to facilitate systematic, scalable, and consistent discovery of business questions that can facilitate data drive decision making in organizations.

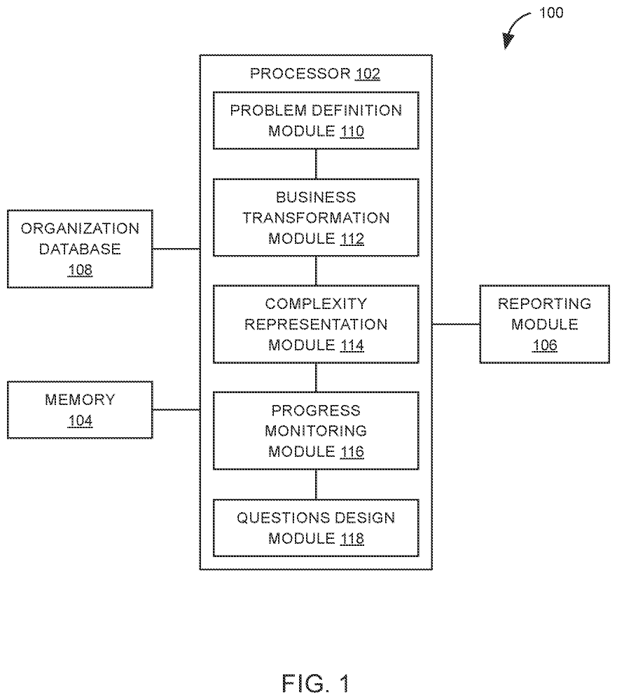

FIG. 1 illustrates an enquiry engine 100 for systematically developing business questions for an organization in accordance with embodiments of the present technique. The system 100 includes one or more processors such as represented by reference numeral 102, a memory 104 and a reporting module 106. Each component of the system 100 is described in further detail below.

Referring again to FIG. 1, the memory 104 has computer-readable instructions stored therein, and the processor 102 is configured to execute the computer-readable instructions to develop business questions for an organization. In the illustrated embodiment, the system 100 includes non-transitory computer readable storage media 108 that is configured to store organizational databases that include business data for the organization.

In this example, the organizational database 108 may include business data such as data related to one or more business functions of the organization. Examples of such data include business performance data, learnings across business functions, solutions implemented for one or more problems across business functions, business questions developed across the business functions, information related to inter-relationships between the business functions, among others. Such data is accessed by the processor 102 and is utilized to efficiently develop business questions for the organization. The organizational database 108 may be an in-house database of the organization or may be accessed from a remote location.

In the illustrated embodiment, the processor 102 includes a problem definition module 110, a business transformation module 112 and a complexity representation module 114. The problem definition module 110 is configured to analyze at least one business problem of an organization and to develop a plurality of hypothesis corresponding to the business problem based on a current state, a desired state and one or more business gaps between the current and desired states. The desired state may be defined by a user of the system 100 such as by one or more business representatives of the organization.

In this example, the business problem may be representative of a problem ontology of the organization. The problem definition module 110 is configured to analyze the business problem and fragment the problem into the plurality of hypothesis to develop one or more relevant business questions for the organization. In one example, the problem definition module 110 further comprises a research module (not shown) configured to determine one or more parameters to address the business gaps between the current and desired states. In operation, the problem definition module 110 is further configured to map each of the plurality of hypothesis to statistical analysis and to identify one or more business questions to address the business gaps between the current and the desired states.

Further, the business transformation module 112 is configured to determine outcomes for the identified business problem over multiple phases, shared behaviors and insights required by a plurality of stakeholders of the organization to achieve the outcomes. In particular, the business transformation module 112 is configured to establish clarity in the problem solving process based on the shared behaviors and the insights.

In one embodiment, the business transformation module 112 is configured to determine business goals, financial goals, or combinations thereof over multiple phases for the organization. Moreover, the business transformation module 112 is further configured to identify shared behaviors required to be exhibited by stakeholders from the business ecosystem and the decision science practitioner ecosystem of the organization to achieve the outcomes.

Furthermore, the business transformation module 112 is further configured to identify insights based on the identified stakeholders in the business and decision science ecosystem that can exhibit the shared behaviors and to map one or more business questions that correspond to the identified insights. In addition, the business transformation module 112 identifies one or more data sources to find solutions to the one or more business questions. The one or more data sources may be internal or external to the organization.

In one example, the business transformation module 112 is configured to map one or more business questions that correspond to the identified insights and monitor progress of solutions developed by stakeholders across the business functions to achieve the desired state.

Further, the complexity representation module 114 is configured to determine and represent organizational complexity and interconnections between problem areas across business functions of the organization. It should be noted that the complexity representation module 114 may access data related to a variety of business functions across the organization and determine inter-relationships across the business functions. Moreover, the complexity representation module 114 may access data related to problem areas and corresponding solutions implemented by the business functions to determine the interconnections. Such data may be accessed via the organization database 108.

In this embodiment, the processor 102 further includes a progress monitoring module 116 and a questions design module 118. The progress monitoring module 116 is configured to communicate with the problem definition module 110, the business transformation module 112, and the complexity representation module 114 to monitor a progress of solutions implemented by different types of stakeholders across the business functions of the organization to achieve the desired state. In one embodiment, the progress monitoring module 116 determines a flow of decisions across the one or more business functions of the organization.

Moreover, the questions design module 118 is configured to integrate information from the problem definition module 110, the business transformation module 112, the complexity representation module 114, and the progress monitoring module 116 to systematically develop one or more business questions corresponding to the business problem. The questions design module 118 is configured to refine the one or more business questions corresponding to the business problem using the business information and solutions. Further, the one or more business questions may be communicated to a user via the reporting module 106 with an output interface.

As described above, the problem definition module 110 is configured to evaluate the business problem and is fragmented into a plurality of granular testable hypothesis irrespective of data availability.

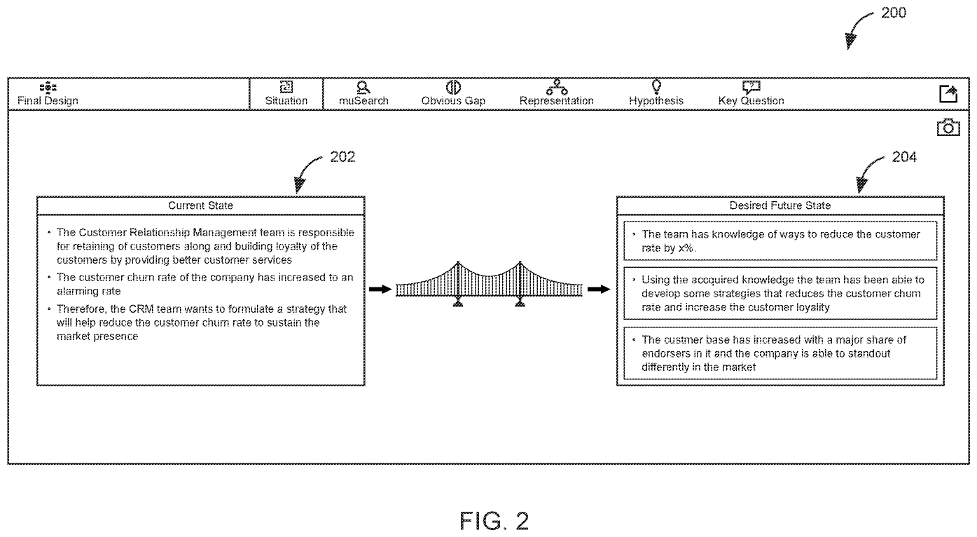

FIG. 2 illustrates an example representation 200 of states of a business problem analyzed by the problem definition module 110 of the system 100 of FIG. 1. As can be seen, a current state and a desired state corresponding to a business problem of an organization are represented by reference numerals 202 and 204. These states may be determined or defined by a representative of the organization using a variety of analytical tools. Further, these may be updated from time-to-time based on a plurality of parameters relevant to the business problem. Once the current and desired states 202 and 204 are defined, a search is performed to identify business gaps between the current and desired states 202 and 204.

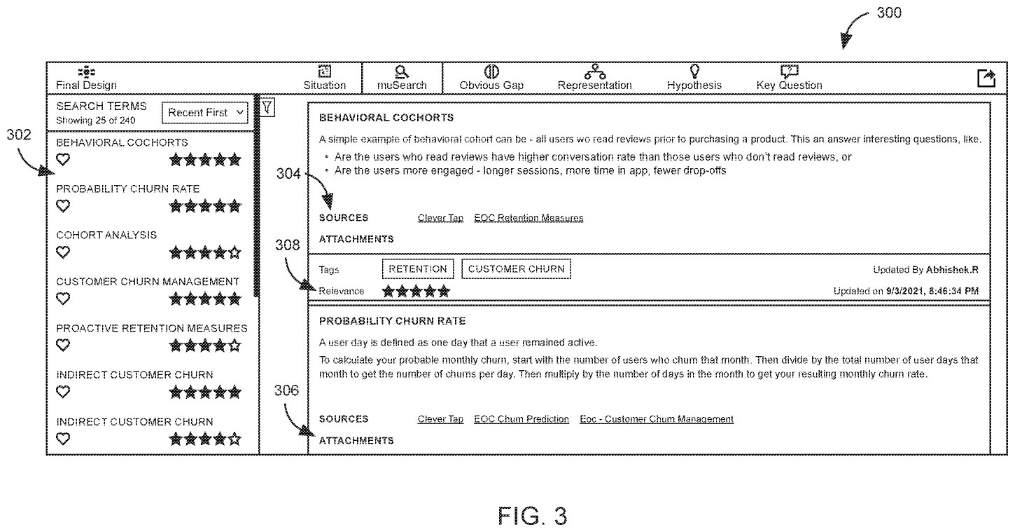

FIG. 3 illustrates an example representation 300 of output from a research module of the system 100 of FIG. 1. The research module is configured to perform and document primary and secondary research related to the business problem identified by the problem definition module 110. In this example, a plurality of search terms such as represented by reference numeral 302 may be used to perform the search related to the business problem. One or more sources 304 used for the search may be defined and displayed to a user of the system and relevant documents 306 corresponding to the search also may be made available to the user. In addition, a relevance for the sources, each of the output result, documents or combinations thereof may be provided as represented by reference numeral 308.

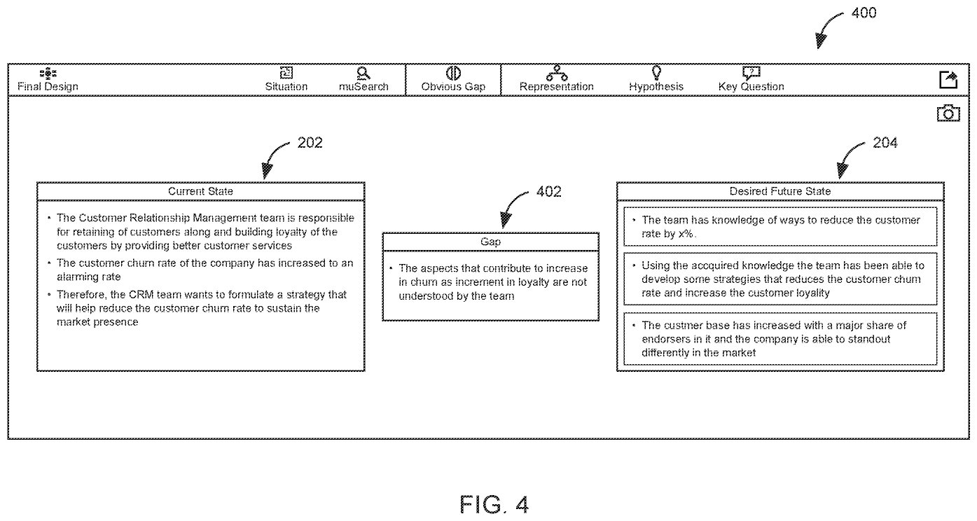

FIG. 4 illustrates an example representation 400 of gaps between the current and desired states as identified by the problem definition module 110 system 100 of FIG. 1. In this example, based on the output from the research module, one or more business gaps 402 between the current and desired states 202 and 204 are identified. Once the business gaps 402 are identified, they are further analyzed to identify factors to address the gaps 402. These business gaps may be available to a user of the system 100 via the reporting module 106.

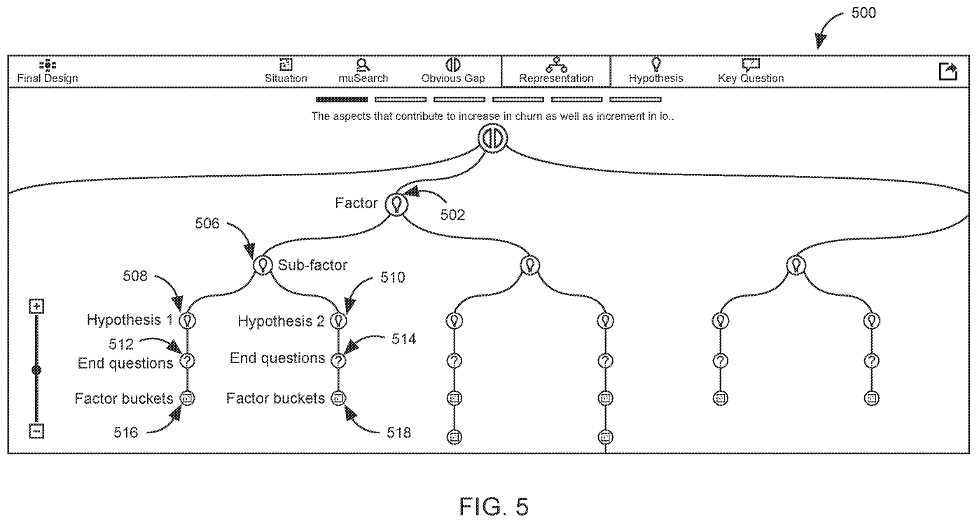

FIG. 5 illustrates an example representation 500 of factors identified for identified business gaps 402 of FIG. 4. In this embodiment, the identified business gaps 402 are analyzed by the processor 102 to determine a plurality of factors such as represented by reference numeral 502. In this example, the factors 502 are further analyzed to determine sub-factors 506 and hypothesis such as represented by reference numerals 508 and 510 that may address the gaps such as 402. Each of the hypothesis 508 and 510 may be utilized to generate end questions represented by reference numerals 512 and 514. In one example, such questions 512 and 514 may be grouped into pre-determined factor buckets such as represented by reference numerals 516 and 518.

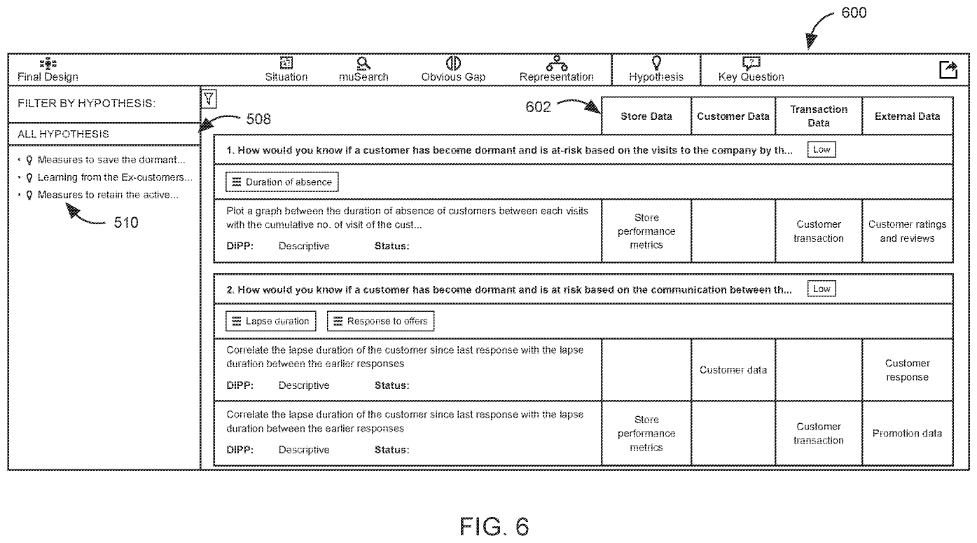

FIG. 6 illustrates an example representation of a hypothesis matrix 600 for the hypothesis 508 and 510 of FIG. 5 generated using the system 100 of FIG. 1. As illustrated, each hypothesis 508 and 510 is mapped to statistical analyses across descriptive, inquisitive, predictive, and prescriptive analytics. Moreover, data 602 required for the various analyses and their availability are also mapped to each hypothesis 508 and 510. Such data 602 may be accessed from a variety of sources.

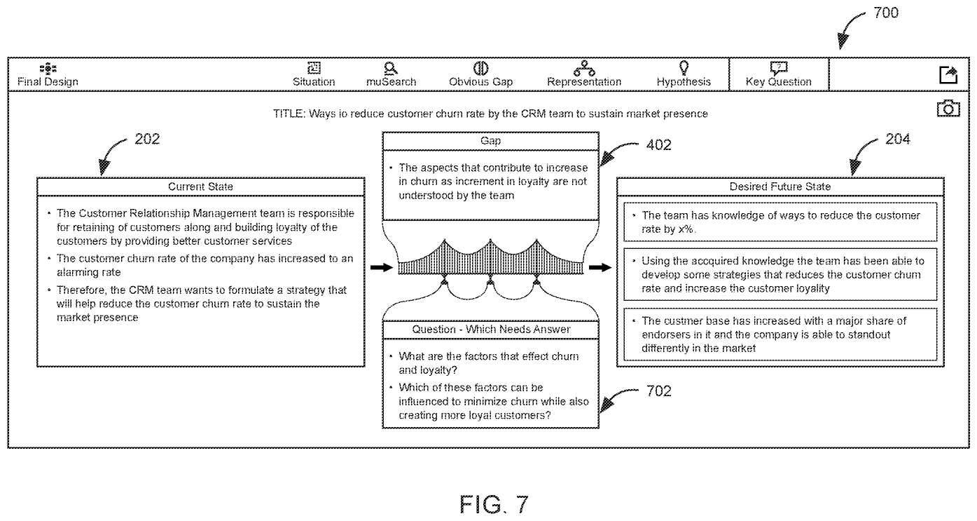

FIG. 7 illustrates an example representation of a key questions 700 generated using the hypothesis matrix 600 of FIG. 6. In this embodiment, based on various hypothesis such as 508 and 510 and the data availability and feasibility of solving one or more key questions such as represented by reference numeral 702 to address the business gap are identified.

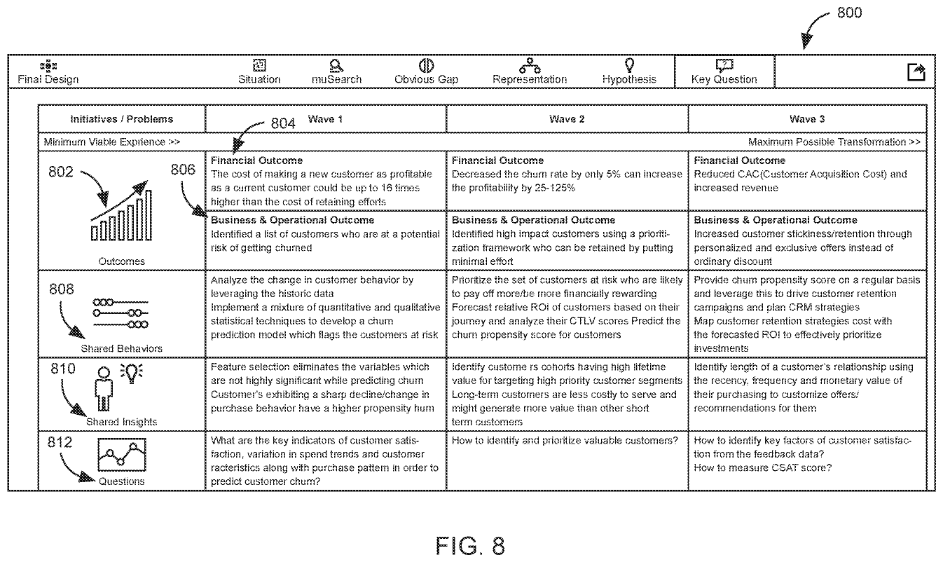

FIG. 8 illustrates an example screenshot of output 800 from the business transformation module 112 of the system 100 of FIG. 1. In this example, the business transformation module 112 is configured to facilitate planning and implementing programmatic transformation to realize long-term values while realizing short-term wins for the organization. As illustrated, outcomes 802 such as business 806 and financial 804 goals are identified here over three waves from minimum viable experience to maximum possible transformation.

Further, shared behaviors 808 from a plurality of stakeholders from the business ecosystem and the decision science practitioner ecosystem are identified. The shared behaviors 808 include behaviors that are required to be exhibited to achieve the desired outcomes 802.

In addition, the the business transformation module 112 is configured to identify shared insights 810 based on which the stakeholders in the business and decision science ecosystem would be able to exhibit the shared behaviors 808. In addition, business questions 812 are mapped that could potentially lead to the insights. Moreover, data sources are identified that include potential sources to help with answering the questions.

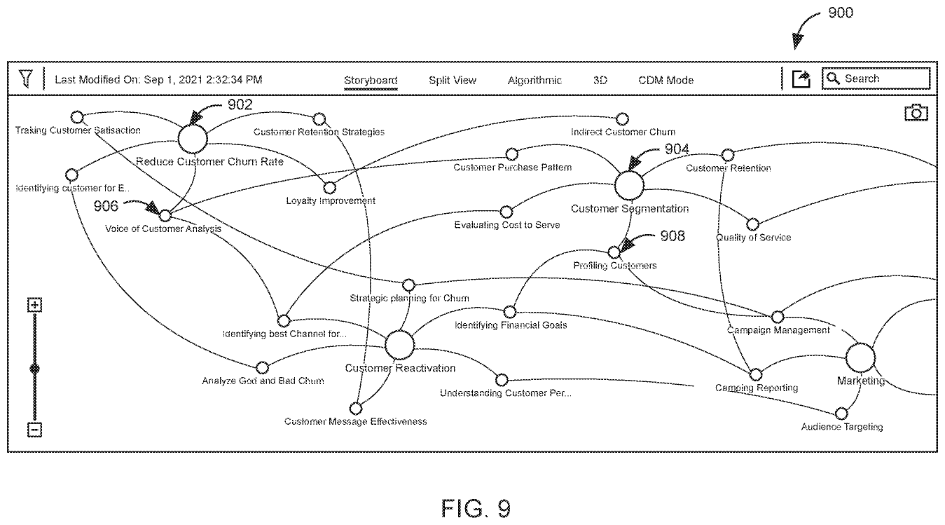

The complexity representation module 114 of FIG. 1 analyzes and represents organizational complexity and interconnections between problem areas across business functions of the organization. FIG. 9 illustrates an example representation 900 of such interactions generated by the complexity representation module 114 of FIG. 1. As illustrated, the representation includes a variety of problem areas such as represented by reference numerals 902 and 904. These problems 902 and 904 may correspond to a business function or may be across business functions. Each of the problems 902 and 904 may be linked to a plurality of sub-problems or factors such as represented by reference numerals 906 and 908 associated with them. The representation 900 provides an integrated view of the complexity and inter-relations across problem areas within the different business functions in the organization and such information is used to develop relevant business questions for the organization.

Moreover, the progress monitoring module 116 communicates with the problem definition module 110, the business transformation module 112, and the complexity representation module 114 to monitor progress of solutions implemented by different types of stakeholders across the business functions to achieve the desired state. Further, the questions design module 118 integrates information from the problem definition module 110, the business transformation module 112, the complexity representation module 114, and the progress monitoring module 116 to systematically develop one or more business questions corresponding to the business problem.

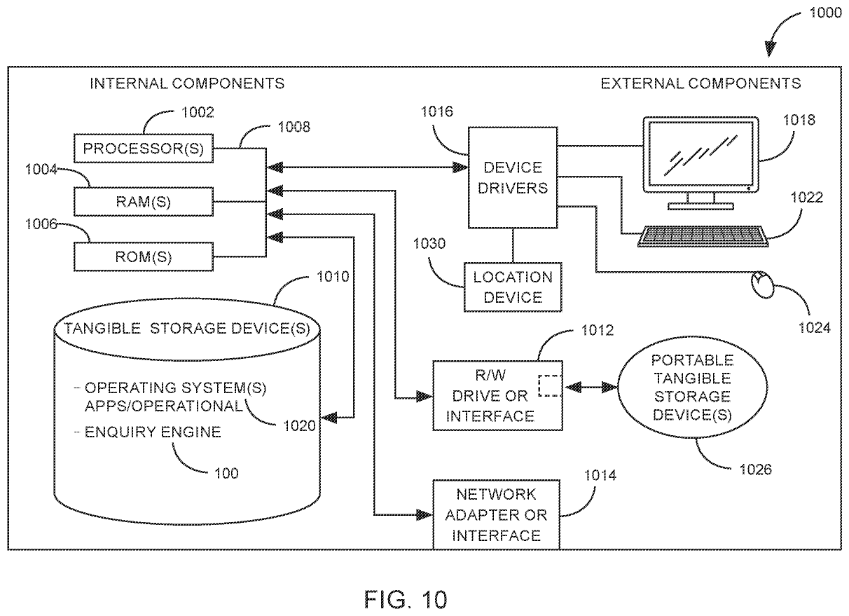

The modules of the system 100 described herein are implemented in computing devices. One example of a computing device 1000 is described below in FIG. 10. The computing device includes one or more processor 1002, one or more computer-readable RAMs 1004 and one or more computer-readable ROMs 1006 on one or more buses 1008. Further, computing device 1000 includes a tangible storage device 1026 that may be used to execute operating systems 1020 and the system 100 to systematically developing business questions for an organization. The various modules of the system 100 may be stored in tangible storage device 1026. Both, the operating system 1020 and the system 1000 are executed by processor 1002 via one or more respective RAMs 1004 (which typically include cache memory). The execution of the operating system 1020 and/or the system 1000 by the processor 1002, configures the processor 1002 as a special purpose processor configured to carry out the functionalities of the operation system 1020 and/or the system 1000, as described above.

Examples of storage devices 1010 include semiconductor storage devices such as ROM 1006, EPROM, flash memory or any other computer-readable tangible storage device that may store a computer program and digital information.

Computing device also includes a R/W drive or interface 1012 to read from and write to one or more portable computer-readable tangible storage devices 1028 such as a CD-ROM, DVD, memory stick or semiconductor storage device. Further, network adapters or interfaces 1014 such as a TCP/IP adapter cards, wireless Wi-Fi interface cards, or 3G or 4G wireless interface cards or other wired or wireless communication links are also included in computing device.

In one example embodiment, the system 1000 which includes a processing unit 1002 and a memory 1006, may be stored in tangible storage device 1010 and may be downloaded from an external computer via a network (for example, the Internet, a local area network or other, wide area network) and network adapter or interface 1014.

Computing device further includes device drivers 1016 to interface with input and output devices. The input and output devices may include a computer display monitor 1018, a keyboard 1022, a keypad, a touch screen, a computer mouse 1024, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. An enquiry engine for systematically developing business questions for an organization, the enquiry platform comprising:
a problem definition module configured to analyze at least one business problem of an organization and to develop a plurality of hypothesis corresponding to the business problem based on a current state, a desired state and one or more business gaps between the current and desired states;
a business transformation module configured to determine outcomes for the business problem over multiple phases, shared behaviors and insights required by a plurality of stakeholders of the organization to achieve the outcomes;
a complexity representation module configured to represent organizational complexity and interconnections between problem areas across business functions of the organization;
a progress monitoring module configured to communicate with the problem definition module, the business transformation module, and the complexity representation module to monitor progress of solutions implemented by different types of stakeholders to achieve the desired state; and
a questions design module configured to integrate information from the problem definition module, the business transformation module, the complexity representation module, and the progress monitoring module to systematically develop one or more business questions corresponding to the business problem.

2. The enquiry engine of claim 1, wherein the problem definition module further comprises a research module configured to determine one or more parameters to address the business gaps between the current and desired states.

3. The enquiry engine of claim 2, wherein the problem definition module is further configured to map each of the plurality of hypothesis to statistical analysis and to identify one or more business questions to address the business gaps between the current and the desired states.

4. The enquiry engine of claim 1, wherein the business transformation module is configured to determine business goals, financial goals, or combinations thereof over multiple phases for the organization.

5. The enquiry engine of claim 1, wherein the business transformation module is further configured to identify shared behaviors required to be exhibited by stakeholders from the business ecosystem and the decision science practitioner ecosystem of the organization to achieve the outcomes.

6. The enquiry engine of claim 5, wherein the business transformation module is further configured to identify insights based on the identified stakeholders in the business and decision science ecosystem that can exhibit the shared behaviors.

7. The enquiry engine of claim 6, wherein the business transformation module is further configured to map one or more business questions that correspond to the identified insights.

8. The enquiry engine of claim 7, wherein the business transformation module is further configured to identify one or more data sources to find solutions to the one or more business questions.

9. The enquiry engine of claim 1, wherein the progress monitoring module is further configured to determine a flow of decisions across the one or more functions of the organization.

10. The enquiry engine of claim 1, further comprising a reporting module configured to communicate the one or more business questions corresponding to the business problem to a user.

11. An enquiry engine for systematically developing business questions for an organization, the enquiry comprising:
a memory having computer-readable instructions stored therein;
a processor configured to:
identify a business problem for the organization;
analyze the business problem of an organization and identify one or more business questions corresponding to the business problem based on a current state, a desired state and one or more business gaps between the current and desired states;
access business information related to the business problem from a plurality of business functions across the organization, wherein the business information comprises outcomes for the business problem, shared behaviors and insights required by a plurality of stakeholders of the organization to achieve the outcomes;
map one or more business questions that correspond to the identified insights and monitor progress of solutions developed by stakeholders across the business functions to achieve the desired state; and
develop and/or refine one or more business questions corresponding to the business problem using the business information and solutions.

12. The enquiry engine of claim 11, wherein the business information further comprises organizational complexity and interconnections between problem areas across business functions of the organization.

13. The enquiry engine of claim 11, wherein the processor is further configured to analyze at least one business problem of an organization and to develop a plurality of hypothesis corresponding to the business problem and to map each of the plurality of hypothesis to statistical analysis to identify the one or more business questions.

14. The enquiry engine of claim 11, wherein the processor is further configured to access one or more data sources to find solutions to the one or more business questions.

15. The enquiry engine of claim 11, wherein the processor is further configured to determine one or more parameters to address gaps between the current and desired states.

16. A computer-implemented method for systematically developing business questions for an organization, the method comprising:
analyzing a business problem of an organization and developing a plurality of hypothesis corresponding to the business problem based on a current state, a desired state and one or more business gaps between the current and desired states;
accessing business information related to the business problem from a plurality of business functions across the organization, wherein the business information comprises outcomes for the business problem, shared behaviors and insights required by a plurality of stakeholders of the organization to achieve the outcomes;
mapping one or more business questions that correspond to the identified insights and monitoring progress of solutions developed by stakeholders across the business functions to achieve the desired state;
identifying organizational complexity and interconnections between problem areas across business functions of the organization; and
developing and/or refining one or more business questions corresponding to the business problem using the business information and solutions.

17. The computer-implemented method of claim 16, further comprising accessing one or more data sources to find solutions to the one or more business questions

18. The computer-implemented method of claim 16, further comprising communicating the one or more business questions corresponding to the business problem to a user.

19. The computer-implemented method of claim 16, further comprising enabling stakeholders of the organization to define one or more business programs based on the business questions and progress of solutions developed by stakeholders across the business functions.

20. The computer-implemented method of claim 19, further comprising determining a flow of decisions across the business functions of the organization.
